(19) United States
(12) Patent Application Publication
(10) Pub. No.: US 2007/0056962 A1
(43) Pub. Date: Mar. 15, 2007

(54) Susceptor panel for brown and crisp microwaving package

(76) Inventors: Gary Hopkins SR., Scottsburg, IN (US); Gary L. Hopkins II, Scottsburg, IN (US)

Correspondence Address: David W. Carrithers;CARRITHERS LAW OFFICE, PLLC, Suite 140, One Paragon Centre, 6060 Dutchman's Lane, Louisville, KY, 40205, US

(21) Appl. No.: 11/407,389

(22) Filed: Apr. 19, 2006

Related U.S. Application Data
(60) Provisional application No. 60/673,189, filed on Apr. 20, 2005.

(51) Int. Cl. H05B 6/80

(52) U.S. Cl. 219/730

(57) ABSTRACT

A container made of material suitable for use in a microwave having a food supporting tray in the container, a film of microwave interactive susceptor material is located at preselected locations within the container and relative to food that is supported on the tray with means for supporting the food support tray in selected space relation with respect to a surface on which the tray rests whereby food on the tray is elevated with respect to such surface.

### SUMMARY

The present invention comprises a container made of material suitable for use in a microwave having a food supporting tray in the container, a film of microwave interactive susceptor material is located at preselected locations within the container and relative to food that is supported on the tray with means for supporting the food support tray in selected space relation with respect to a surface on which the tray rests whereby food on the tray is elevated with respect to such surface.

Moreover, the present invention provides for a tray on which food can be placed for heating in a microwave wherein the tray comprises a paperboard blank having a central area surrounded by predefined fold lines defining a polygon. A first panel extending from each of respective ones of the fold lines. Each of the panels being generally rectangular and having a width parallel to and which is shorter than the length of the fold line associated therewith. A tab projects laterally from respective ones of the panels and means are provided for connecting the tab of one panel to the next adjacent panel. Folding the panels along their respective fold lines projects them upwardly from the periphery of the central area wherein a portion of at least selected ones of the panels have a portion thereof projecting downwardly from the central area to support the tray on a suitable surface with the central portion of the tray elevated with respect to such surface and a film of susceptor material disposed on at least selected area portions of the central area and the panels.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a perspective view of a frozen food package according to one embodiment of the present invention.

FIG. 2 is a perspective view thereof with one end opened and showing the end of the food support tray inside.

FIG. 3 is a perspective view of the food support tray incorporating the susceptor and erected according to the one embodiment of the present invention.

FIG. 4 is a perspective view of a flat blank with susceptor prior to erection into the food support tray of FIGS. 2 and 3.

FIG. 5 is a top plan view of the blank of FIG. 4 from which the tray of FIG. 3 is formed.

FIG. 6 is a perspective view of the blank showing more detail than FIG. 4.

FIG. 7 is a top plan view of the food support tray erected.

FIG. 8 is a cross sectional view taken at line 8-8 in FIG. 7 and viewed in the direction of the arrows.

FIG. 9 is a perspective view of the food support tray erected but shown on a smaller scale than the previous figures.

FIG. 10 is an enlarged section of a portion of the support tray floor and support tabs, taken at line 10-10 in FIG. 7 and viewed in the direction of the arrows.

FIG. 11 is a bottom view of the portion of the support tray floor shown in FIG. 10.

FIG. 12 is a view similar to FIG. 5 but is a bottom plan view for another embodiment of food support tray incorporating a susceptor.

FIG. 13 is a bottom plan view of this food tray of FIG. 12 but erected in a manner similar to FIGS. 3 and 9.

FIG. 14 is a top plan view of the erected food support tray erected from the blank of FIG. 12.

FIG. 15 is a perspective view of a frozen food package according to another embodiment of the present invention.

FIG. 16 is a top plan view of the blank assembly which, when erected, forms the package of FIG. 15.

### DESCRIPTION OF THE ILLUSTRATED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated and described and embodied therein being contemplated as would normally occur to one skilled in the art to which the invention relates, are intended to be protected.

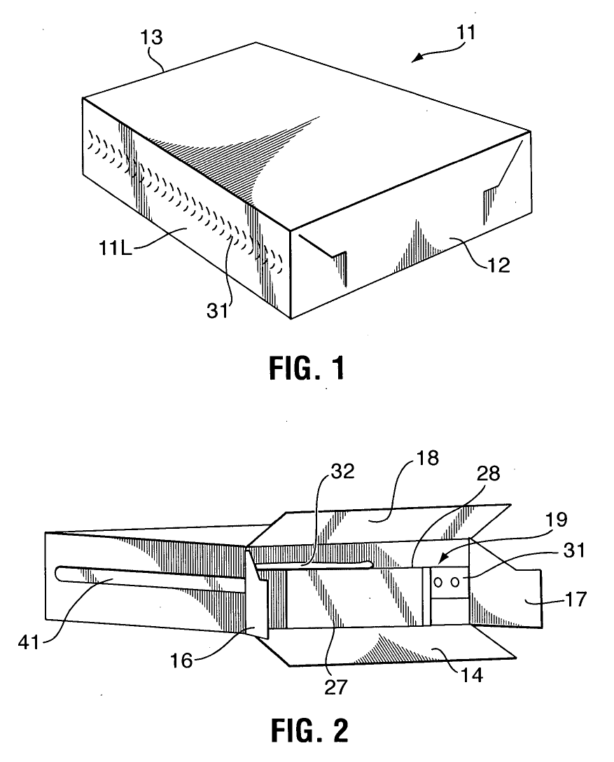

Referring now to FIG. 1, there is shown a box 11 made of sulfur bleached substrate (S.B.S.) paperboard having rectangular top and bottom and side walls, with front and rear walls 12 and 13 formed of turned flaps with inter-fitting tabs and slots to close the box. FIG. 2 shows this box with the front flaps open, including the lower flap 14, side flaps 16 and 17, and upper flap 18 which becomes the outer flap when the box is closed. There is a tray 19 received in the box and which is a susceptor-lined S.B.S. paperboard food supporting tray for browning or crisping the surface of a food product, a pizza, for example, supported on the tray.

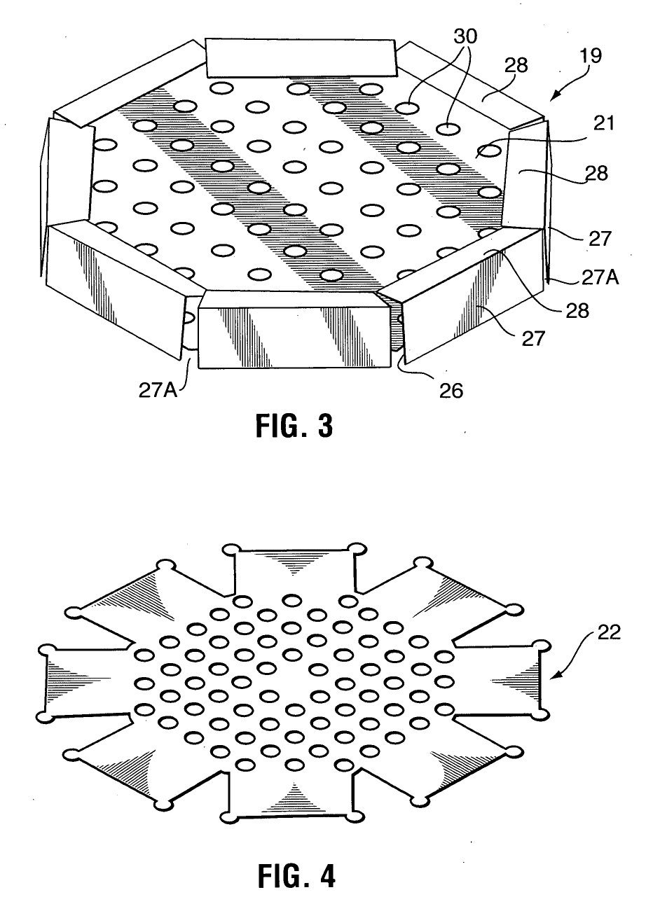

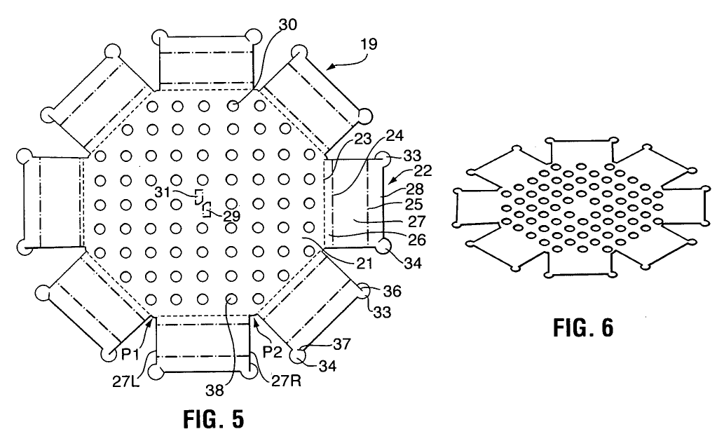

Referring now to the remaining figures, the food supporting tray 19 is made of a paperboard blank shown in FIG. 5 and having a generally octagonal shape with a pattern of cuts and grooves defining various features including, among others, an octagonal shaped central portion 21 with extensions such as 22 projecting outwardly from each of the eight sides of the central portion. Each of these extensions has fold lines at 23, 24 and 25, at which bends will be made to erect the blank into the configuration such as shown in FIGS. 3, 7, 8 and 9.

For erection of the blank into the food support tray, each extension such as 22 is turned downward at line 23 to vertical and then turned upward 180 degrees at line 24 to vertical and then horizontally at line 25. This results in the tab being formed into three panels, 26 projecting downward, 27 projecting upward from the lower end of 26, and 28 projecting horizontally inward from the top of panel 26. So the tray now has a floor 21 spaced above a plane “A”, FIG. 8, which can be a table top, the bottom of box 11, or any other suitable surface.

Since all of extensions 22 may be the same, and although not essential that it be so, and for convenience, the one shown at the bottom of FIG. 5 will be described further. The distance between opposite free edges 27L and 27R is less than the distance between the corners P1 and P2 of floor 21. This facilitates circulation under floor 21 and around as will be seen the tray.

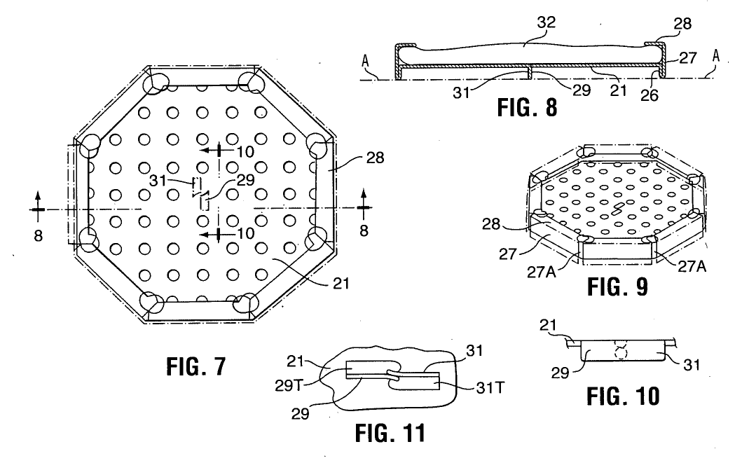

At the center of the tray floor 21 there are two score lines which facilitate punching material downward to provide two central support tabs 29 and 31 shown in FIGS. 5 through 11. The score lines for the openings 29T and 31T for each of these tabs has a sort of S-shaped edge which faces the similar edge of the other tab as shown in FIGS. 7, 10 and 11. When turned down as shown in FIG. 8, these tab ends can be manually bent into overlapping relationship on opposite sides of each other as shown in FIG. 11. Therefore, when overlapped on opposite sides, they remain in place and provide any support which might be needed for the center of the floor 21 to adequately support a pizza 32.

With the microwave interactive layer atop the paperboard, it is effective when the blank is erected to provide a face supporting the crust at the bottom of the pizza and also facing the sides of the crust around the entirety of the perimeter of the pizza, as well as the portion of the pizza crust at the top around the perimeter of the pizza. Thus, the interactive layer provides a susceptor and is well situated to provide the desired browning and crisping of the bottom of the crust and the sides of the crust and the top of the pizza crust around the perimeter of the top of the pizza.

An additional feature of this food support tray is the provision of the multiplicity of vent holes 30 through the floor 21 at the bottom to permit and facilitate the movement of air to the food product and moisture out of it if and as desired, depending upon the exact nature of the food product, pizza or otherwise, in the container. As particularly evident in FIGS. 3 and 9, there is space between neighboring edges 27L and 27R of panels 27 of the extensions 22, enabling movement of gases from and to the space between the bottom of floor 21 and a supporting surface (plane “A”, FIG. 8) such as the bottom of box 11, for example.

Another feature of this embodiment is the arrangement to keep the top flaps 28 facing inward over the edge of the pizza. For this purpose, small “ears” 33 are provided at the outboard corners of each of the extensions 22. Each of these is semi-circular shaped and has a cut line at the leading edge of the ear as at 36 for ear 33 and 37 for ear 34. The term “leading edge” as used herein refers to the portion of the ear which would be in front if the tray were rotated in a counterclockwise direction around an axis perpendicular to the plane “A”. With this arrangement, and when the walls of all of the extensions are turned upward and the flaps 27 turned inward, the ear of one tab can be interlocked with the ear of the next adjacent tab. Thus, the entire set of in-turned flaps 28 can be retained over the edge of the food product. Also, because there is overlap of the ears at the corners, they can be glued together, if desired in addition to or instead of interlocking. Pressure sensitive adhesive is one example of a method of adhesively attaching the ears of adjacent flaps together.

To prepare for the packaging process, the blank is simply erected into a food support tray. To do this, center tabs are pressed from the floor 21 and down to provide the center supports 29 and 31. The edge extensions are turned down for panel 26 and folded upward at score line 25 for panel 27. Then the pizza is placed on the tray floor 21. Then the flaps 28 are turned down horizontally and inward over the top of the pizza crust at the edges of the pizza. Then the ears are interlocked or adhesively, stapled or otherwise secured together, and the tray supporting the pizza is inserted into the box 11 which is then closed and stored in a freezer or other refrigeration of a nature depending upon anticipated date or time of the intended use. At the time for cooking, the box 11 can be opened, or remain closed and closure strips 41 covering the series of ports 42 along the sides of the box can be pulled off to permit any needed venting. Then the package may be heated in a microwave oven. It should be understood that the tray according to the illustrated embodiment of the present invention is sturdy enough that, if desired, the pizza on the tray can be removed from the box for microwave cooking separate from the box. If desired, the tray can be used in boxes of other shapes and which can have its opening at the side or end as in FIG. 2 or at the top or otherwise.

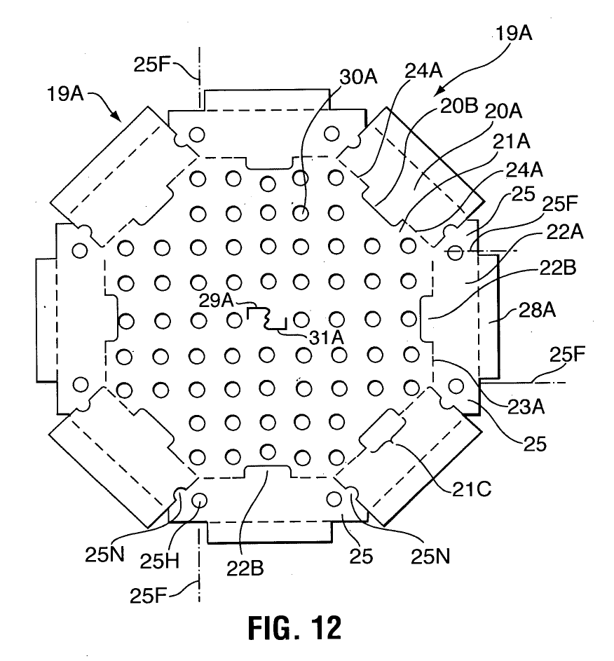

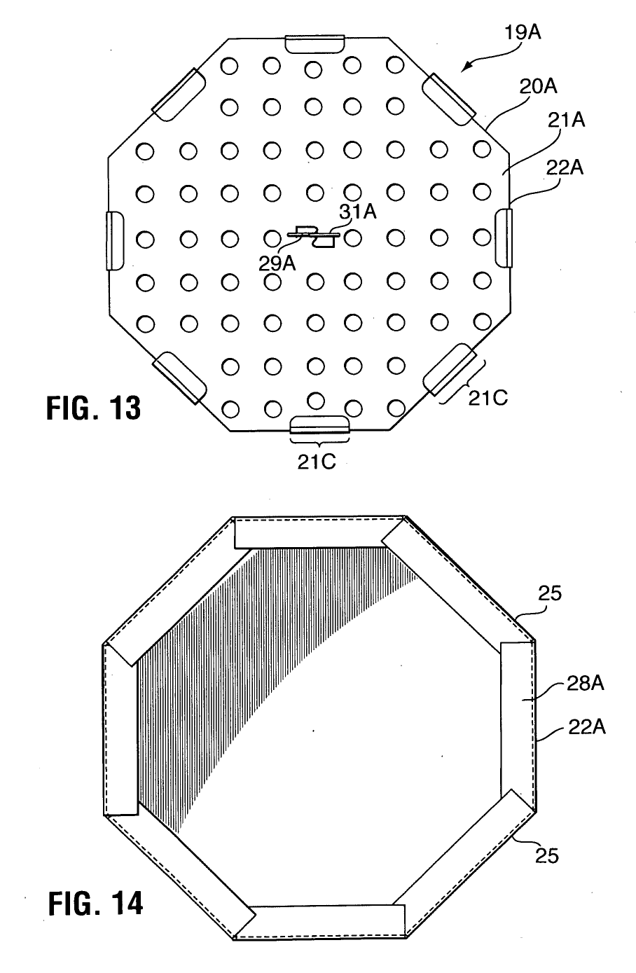

Referring now to FIGS. 12-14, an alternate embodiment of the food support tray of the previously described figures is shown. The tray 19A may be made of the same material as described for the first embodiment. It has a hexagonal floor portion 21A with fold lines at all eight sides defining extensions which, in contrast to the previous embodiment will be bent upward at the fold lines to provide the perimeter walls of the food tray. There are two sets of extensions. Four of the extensions in one set are identical to each other, and four of the extensions in the other set are identical to each other but slightly different from those in the one set. For example, tab 20A has straight edges with notches in them, whereas tab 22A has trapezoidal edges. To erect this food tray, all of the extensions such as 20A are turned at the hinge lines such as 24A, and all of the extensions 22A are turned at the hinge lines such as 23A. Then the trapezoidal edge portions 25 of the extensions 22A are turned horizontally such as around lines 25F, into position against the outside faces of extensions 20A to which they can be glued or stapled or otherwise secured, thus holding all of the extensions 20A and 22A erect, forming the octagonal wall of the food support tray. The center support tabs 29A and 31A are pushed out of the blank and interlocked to support the floor 21A as in the previously described embodiment. Because the floor 21A has a cut such as 21C at each of the extensions such as 20A and 22A, it happens that when the wall extensions 20A and 22A are turned at the hinge lines, the portions 20B and 22B of the wall extensions inside the cuts will project away from the floor 21A to the same distance as do the central support tabs 29 and 31. Thereby these portions 20B and 22B serve as legs and support the tray floor 21A spaced above the floor of the box in a manner similar to the portions 26 of the extensions of the previously described embodiment support the floor of that embodiment above the bottom of the box. Therefore, venting through the holes 30A of the array of holes in the floor to the space between the floor and the bottom of the box is achieved. Additional venting at the corners is available through the holes 25H in the extensions 25 and the notches 25N in the extensions 20A at the corners of the structure when the walls are erected to the vertical condition. Then the flaps 28A of all of the extensions 20A and 22A can be turned inward as in the previous embodiment. After the pizza or other food product is on the tray, the flaps 28A can be turned further inward and down on top of the edges of the pizza crust and, where the corners of the adjacent flaps 28A meet, they can be glued or otherwise secured together to cover the top of the edges of the pizza.

As previously described for the other embodiment, the susceptor material is preferably provided on the entire top of the blank from which the tray is formed so that when the walls are erected, and the top flaps 28A turned in over the edges of the pizza, all of these susceptor faces will be in contact with the bottom, sides and tops of the edges of the pizza.

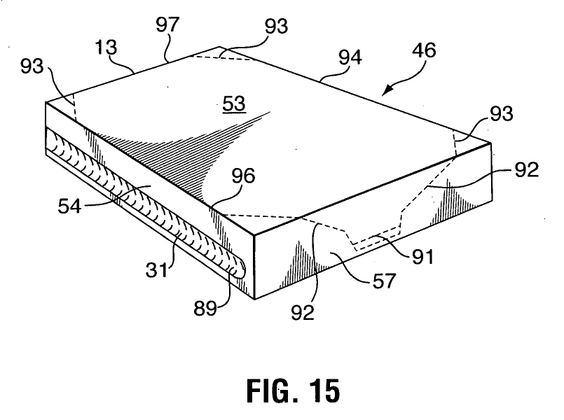

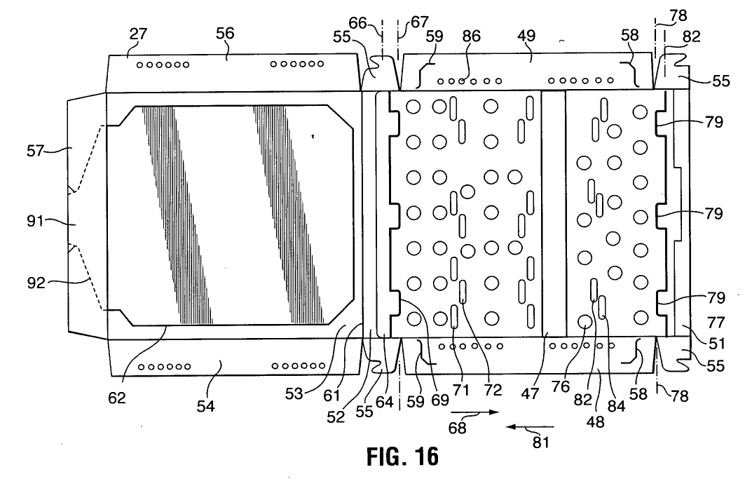

Referring now to FIGS. 15 and 16, a further embodiment of the invention is illustrated. As is true for the trays of the previously described embodiments, the box 46 of the FIGS. 15 and 16 embodiments is made of sulphur bleached substrate (S.B.S.) paperboard to which is mounted susceptor material in three locations which will be described.

The box blank includes a base panel 47 (which becomes the box bottom) with side flaps 48 and 49, front end flap 51, and rear end panel 52. The blank also has a top lid forming panel 53 with side flaps 54 and 56 and front end flap 57. To erect the box, the side flaps 48 and 49 of the bottom panel 47 are turned up, the end flap 51 and rear end panel 52 are also turned up and the ears 55 on the end flap and end panel are inserted into the slots 58 and 59 of the side flaps to lock the sides and ends together, forming the wall of the box bottom unit. After placing a food product in the box, the lid-forming top panel 53 can be bent turned around the fold line 61 to cover the box. Then the side and end flaps of the lid can be bent down around the side and front end flaps and glued or otherwise sealed to close the box.

Susceptors are provided in this box. One of them is the susceptor 62 on the lid. As an example, it may be made of an aluminum-coated film laminated to a 0.014 gauge S.B.S. board sulphuric bleached substrate which is then glued, laminated or otherwise secured to the material of the lid 53 itself and will face downward toward the food product that is to be contained by the box.

Another susceptor is shown at 63 in FIG. 12. It is made of a material similar to that described for susceptor 62 but it also is provided with a plurality of holes and slots and a rear end tab 64. This susceptor is groove along a line 66 which is parallel to the line 67. Line 67 is the hinge line at which the rear end tab 52 of the bottom panel 47 of the box is turned upward when erecting the box. The susceptor tab 64 is glued or otherwise secured to the end panel 52 of the box so that, when the panel 52 is turned upward at the line 67, the susceptor tab goes with it. As this happens, the susceptor 63 is pushed forward in the direction of arrow 68 toward the front of the box. As this occurs, the rear edge of susceptor 63 pivots at the line 66 which moves upward relative to axis 67 along with the end panel 52 whereby a hinge action occurs and the rear end of the susceptor 63 is raised above the bottom panel 47 a distance equal to the spacing between the hinge axis 66 and hinge axis 67. This is possible because the cuts 69 around three sides of the tab 64 at three locations on the tab and susceptor 63 enable the susceptor to hinge at line 66 as the end panel 52 is raised. Tab sets 71 and 72 like 29 and 31 of the previously described embodiments, are situated at multiple spaced locations on the susceptor 63 and pushed down and interlocked as described above and shown in FIGS. 8-11, to support the susceptor 63 above the box bottom panel 47 a distance essentially equal to the distance between the hinge lines 66 and 67.

Similar to the above description, susceptor panel 76 has a tab 77 glued or otherwise attached to the inside face of the box end flap 51. Tab 77 will rise as the box end flap 51 turns upward at the hinge line 78. Cuts 79 in the front portion of susceptor panel 76 at three sides of each of three locations 79, and the fold lines along line 82 between the cuts, enable the box end flap 51 to be raised turning upward around hinge line 78. As the susceptor panel tab 77 swings upward (being attached to the end flap 51) with end flap 51 around the axis 78, the cuts 79 in the front portion of susceptor panel 76 at three sides of each of three locations 79, and the hinge lines along line 82 between the cuts, enable the susceptor panel tab 77 to push panel 76 in the direction of arrow 81. As the tab 77 swings upward, the hinge 82 from it to the susceptor panel 76 rises above the box bottom panel 47 a distance equal to the distance between the hinge axes 78 and 82. Thus, the front end of susceptor panel 76 will be spaced that distance above the box bottom 47. The rear portion of susceptor panel 76 is supported above the box bottom 47 by tab sets 83 and 84 located at three locations near the rear edge of the susceptor panel 76 and functioning in the same way as described above with reference to sets 71 and 72 and those in the previously described embodiments. So it is seen that, as the front end flap 51 and rear end panel 52 of the box bottom 47 are turned upward, the hinged action at lines 82 and 66 causes the rear edge of susceptor panel 76 to approach the front edge of susceptor panel 63, closing the gap shown at the reference line 47 in the drawing of FIG. 16. So the meeting of the edge portions of these susceptor panels provides a continuous perforated floor for the supporting the food product to be microwaved.

When the box is erected, the food product can be placed on the susceptor panels 63 and 76 whereby it is supported above the box bottom a distance equal to the height of the susceptor tabs. As indicated above, that is the distance between the hinge lines 66 and 67 and which are the same as the distance between hinge lines 78 and 82. When the box lid is closed down over the food products supported on the susceptors, the top susceptor 62 is in close proximity or in contact with the food products. Some examples of the food products may be in the fried or French fried potato strip form. Then the side flaps 54 and 56 and end flap 57 can be glued or otherwise sealed to the side and end flaps of the box.

Sets of holes 86 are provided on the side flaps 48 and 49 of the box. Sets of matching holes 87 are provided on the side flaps 54 and 56 of the lid. Therefore, when the lid is closed, the holes on the box sides will be in registry with the holes in the lid side flaps. The holes on the lid side flaps are covered by tear-away strips on the outsides of the flaps 56 and 54. These holes are at a level below the susceptors 63 and 76 and result in there being the opportunity for venting the space under the susceptors through the holes to the outside of the box when cooking is being done. Provision of zip strips opening a row of vents down both sides of the package enable added air flow to enhance the browning and crisping while the vented susceptor lined floor 63/76 allows oils, grease and fat to move from the food product through the floor holes and collect on the bottom of the box. The expected results are a crisper “fry” with less grease.

It should be understood that when the box is closed, the flaps 57 will be glued or otherwise secured to the outside face of the end flap 51 at the front of the box. A pull tab 91 and score lines such as 92 on the front of the cover flap 57, and score lines 93 at the corners and along the upper side edges 94 and 96 and upper rear edge 97 of the lid, make it possible to easily tear-off the top (including the susceptor 62) to open the box and push the susceptor panel of the lid down inside the side walls of the box, with the susceptor against the top of the food product in the box to assure good contact and nice browning of the food product during the cooking process.

Another inventive feature which can be implemented in the various embodiments of this invention is making the paperboard fire resistant and moisture resistant for packages needing high temperature resistance. A material which we propose to use for this purpose is boric acid or sodium borate as a component of the paperboard or paper. Some examples of materials useful in the practice of the invention are mentioned above. A film found suitable for the susceptor panels is Hostaphan 2400 polyester film available from Mitsubishi Polyester Film, LLC of Greer S.C.

We claim:

1. A container made of material suitable for use in a microwave, a food supporting tray in said container, a film of microwave interactive susceptor material located at preselected locations within said container and relative to food that is supported on the tray and means supporting said food support tray in selected space relation with respect to a surface on which the tray rests whereby food on the tray is elevated with respect to such surface.

2. The container and tray as defined in claim 1 wherein said tray spacing means project downwardly from said tray

3. The container and tray as defined in claim 2 wherein said tray spacing means is integral with said tray.

4. The container and tray as defined in claim 1 wherein said interactive susceptor a susceptor film located on selected surfaces of said tray.

5. The container and tray as defined in claim 1 wherein said tray has upstanding walls disposed around a central portion of the tray on which food is located during use.

6. The container and tray as defined in claim 5 including flanges extending inwardly from said upstanding walls to overlie selected food supporting portions of said tray.

7. The container and tray as defined in claim 1 wherein said tray comprises a one piece blank folded along defined fold lines providing a centrally disposed food supporting portion and a first plurality of upstanding flaps located around the outer periphery thereof.

8. The container and tray as defined in claim 7 wherein said susceptor material is located on said flaps and food supporting central portion

9. The container and tray as defined in claim 7 including a second plurality of flaps extending inwardly from said upstanding walls and overlying at least a selected outer peripheral portion of said food supporting portion of the tray.

10. The container and tray as defined in claim 9 wherein said susceptor material is located on said first and second plurality of flaps and said food supporting central portion.

11. The container and tray as defined in claim 7 wherein at least selected ones of said first plurality of flanges have a portion thereof projecting downwardly from said food supporting central portion and thereby providing said means supporting the same at an elevated position.

12. The container and tray as defined in claim 7 wherein said food supporting central area is planar.

13. The container and tray as defined in claim 7 including at least one tab projecting laterally from each of said plurality of flaps and means connecting the tab on one flap to the next adjacent flap.

14. The container and tray as defined in claim 13 wherein side edges of adjacently disposed flaps are spaced a selected distance from one another.

15. The container and tray as defined in claim 14 including a plurality of holes extending through said food supporting central area of the tray.

16. A tray on which food can be placed for heating in a microwave, said tray comprising a paperboard blank having a central area surrounded by predefined fold lines defining a polygon, a first panel extending from each of respective ones of said fold lines, each said panel being generally rectangular and having a width parallel to and which is shorter than the length of the fold line associated therewith, a tab projecting laterally from respective ones of said panels, means for connect the tab of one panel to the next adjacent panel when the panels are folded along their respective fold lines to project upwardly from the periphery of said central area and wherein a portion of at least selected ones of said panels have a portion thereof projecting downwardly from said central area to support the tray on a suitable surface with the central portion of the tray elevated with respect to such surface and a film of susceptor material disposed on at least selected area portions of said central area and said panels.

17. A container and tray as defined in claim 17 including a plurality of holes through said central area and disposed in spaced apart relation relative to one another.

18. The container and tray as defined in claim 17 wherein said paperboard blank is a sulphur based substrate paperboard.

19. The container and tray as defined in claim 17 including score lines in said central area defining punch out tabs that can be struck out downwardly to provide additional support for the tray in its elevated position.

20. The container and tray as defined in claim 19 wherein said punch out tabs are arranged in pairs and with one in the pair engaging the other to retain the same in their load supporting position after they have been punched out.

21. The container and tray as defined in claim 17 wherein each said panel has a fold line defining an outer end panel portion that is foldable inwardly to overlie an outer peripheral portion of said central area.
